(19) United States
(12) Patent Application Publication
(10) Pub. No.: US 2022/0148434 A1
(43) Pub. Date: May 12, 2022

(54) SYSTEM AND METHOD FOR SELECTING LONG-LASTING ANCHOR BASE STATIONS FOR UNMANNED AERIAL VEHICLES

(71) Applicants: AT&T Technical Services Company, Inc., Vienna, VA (US); AT&T Intellectual Property I, L.P., Atlanta, GA (US)

(72) Inventors: Daniel Vivanco, Ashburn, VA (US); David Ross Beppler, Duluth, GA (US); Slawomir Stawiarski, Carpentersville, IL (US)

(21) Appl. No.: 17/094,990

(22) Filed: Nov. 11, 2020

(51) Int. Cl. G08G 5/00; H04B 7/185; H04W 36/32; H04W 36/00; B64C 39/02

(52) U.S. Cl. CPC G08G 5/003; G08G 5/0013; G08G 5/0069; H04B 7/18504; H04B 7/18506; B64C 2201/145; H04W 36/00835; H04W 36/00837; B64C 39/024; B64C 2201/122; H04W 36/32

(57) ABSTRACT

A device includes a processor and a memory. The processor effectuates operations including receiving an origination location and a destination location. The processor further effectuates operations including generating a coverage map comprising a plurality of coverage areas and one or more coverage overlaps based on the origination location and the destination location. The processor further effectuates operations including determining one or more anchor base stations using the coverage map. The processor further effectuates operations including determining a flight plan comprising a flight route and one or more flight rules used to travel from the origination location to the destination location. The processor further effectuates operations including transmitting the flight plan to one or more unmanned aerial vehicles (UAVs).

### TECHNICAL FIELD

This disclosure is directed to methods and systems for controlling unmanned vehicles (UVs), and more particularly to methods and systems that uses software defined machine concepts for an Unmanned Arial Vehicle (“UAV”).

### BACKGROUND

UAVs may be mobile platforms capable of acquiring (e.g., sensing) information, delivering goods, handling objects, and/or performing other actions, in many operating scenarios/applications. UAVs may be utilized to travel to remote locations that are inaccessible to manned vehicles, locations that are dangerous to humans, and/or any other locations more suited for unmanned vehicles than manned vehicles. Upon reaching such locations, UAVs can perform many actions, such as acquiring sensor data (e.g., audio, image, video, and/or other sensor data) at a target location, delivering goods (e.g., packages, medical supplies, food supplies, engineering materials, etc.) to the target location, handling objects (e.g., retrieving objects, operating equipment, repairing equipment, etc.) at the target location, and so forth. In the various operating scenarios/applications, the actions performed by the UAVs may require navigating the UAVs and maintaining network connectivity, such as connectivity to a cellular network.

This background information is provided to reveal information believed by the applicant to be of possible relevance. No admission is necessarily intended, nor should be construed, that any of the preceding information constitutes prior art.

### SUMMARY

The present disclosure is directed to a device having a processor and a memory coupled with the processor. The processor effectuates operations including receiving an origination location and a destination location. The processor further effectuates operations including generating a coverage map comprising a plurality of coverage areas and one or more coverage overlaps based on the origination location and the destination location. The processor further effectuates operations including determining one or more anchor base stations using the coverage map. The processor further effectuates operations including determining a flight plan comprising a flight route and one or more flight rules used to travel from the origination location to the destination location. The processor further effectuates operations including transmitting the flight plan to one or more unmanned aerial vehicles (UAVs).

The present disclosure is directed to a computer-implemented method. The computer-implemented method includes receiving, by a processor, an origination location and a destination location. The computer-implemented method further includes generating, by the processor, a coverage map comprising a plurality of coverage areas and one or more coverage overlaps based on the origination location and the destination location. The computer-implemented method further includes determining, by the processor, one or more anchor base stations using the coverage map. The computer-implemented method further includes determining, by the processor, a flight plan comprising a flight route and one or more flight rules used to travel from the origination location to the destination location. The computer-implemented method further includes transmitting, by the processor, the flight plan to one or more unmanned aerial vehicles (UAVs).

The present disclosure is directed to a computer-readable storage medium storing executable instructions that when executed by a computing device cause said computing device to effectuate operations including receiving an origination location and a destination location. Operations further include generating a coverage map comprising a plurality of coverage areas and one or more coverage overlaps based on the origination location and the destination location. Operations further include determining one or more anchor base stations using the coverage map. Operations further include determining a flight plan comprising a flight route and one or more flight rules used to travel from the origination location to the destination location. Operations further include transmitting the flight plan to one or more unmanned aerial vehicles (UAVs).

### BRIEF DESCRIPTION OF THE DRAWINGS

Aspects of the herein described telecommunications network and systems and methods are described more fully with reference to the accompanying drawings, which provide examples. In the following description, for purposes of explanation, numerous specific details are set forth in order to provide an understanding of the variations in implementing the disclosed technology. However, the instant disclosure may take many different forms and should not be construed as limited to the examples set forth herein. Where practical, like numbers refer to like elements throughout.

FIG. 1 is an exemplary operating environment in accordance with the present disclosure;

FIG. 2 is an exemplary environment in accordance with the present disclosure;

FIG. 3 is an exemplary handover procedure in accordance with the present disclosure;

FIG. 4 is a flowchart of an exemplary method of operation in accordance with the present disclosure;

FIG. 5 is a flowchart of an exemplary method of operation in accordance with the present disclosure;

FIG. 6 is a schematic of an exemplary network device;

FIG. 7 depicts an exemplary communication system that provide wireless telecommunication services over wireless communication networks with which edge computing node may communicate;

FIG. 8 depicts an exemplary communication system that provide wireless telecommunication services over wireless communication networks with which edge computing node may communicate;

FIG. 9 is a diagram of an exemplary telecommunications system in which the disclosed methods and processes may be implemented with which edge computing node may communicate;

FIG. 10 is an example system diagram of a radio access network and a core network with which edge computing node may communicate.

### DETAILED DESCRIPTION

Many implementations of unmanned aerial vehicles (UAVs) require beyond visual line-of-sight (LOS) communications. Telecommunication networks offer wide area, high speed, and secure wireless connectivity, which can enhance control and safety of UAV operations and enable beyond visual LOS.

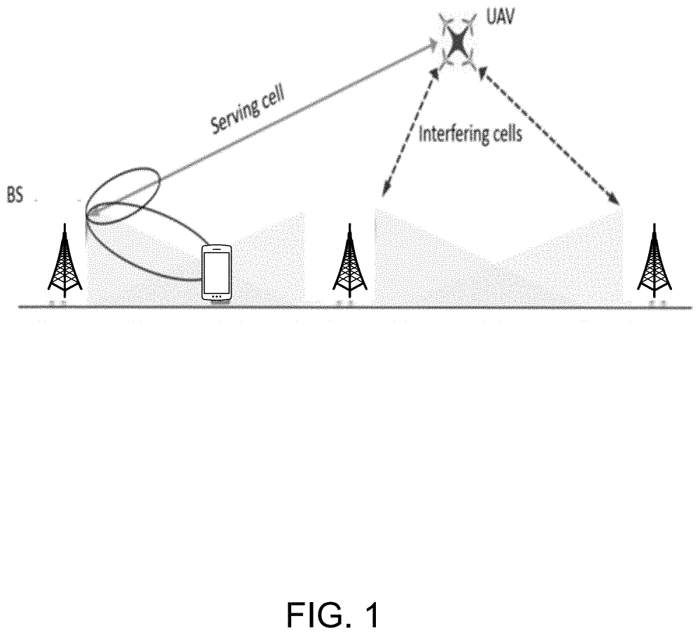

During operation (e.g., transporting something from one location to another location) at a given location, a UAV connects to a base station (e.g., evolved NodeBs (eNodeBs or eNBs) or next generation NodeBs (gNodeBs or gNBs) having a strongest signal strength, which is typically a base station that is geographically closest to the UAV. Because current implementations of communication networks utilize base stations and are focused on terrestrial based communications (e.g., mobile phone to mobile phone communications) instead of aerial based communications, as well as close-to-free-space propagation of signals (e.g., side lobes) generated by base stations above a given altitude tending to overlap, a UAV may detect multiple base stations at a given location during operation (see FIG. 1).

Because the UAV may detect several base stations during operation where the signal strength for each base station may vary due to the UAV changing position or altitude or due to radio signal fading, the UAV may switch base station connections to the base station with the strongest signal strength (a handover). The variance in signal strength due to the UAV changing position or altitude during operation may cause the UAV to perform frequent handovers. Each handover drains the UAV battery. In addition, frequent handovers may lead to large signaling overhead (e.g., communications with a connected base station, a soon to be connected base station, and UAV management system 135). Preserving battery power is a significant issue for a UAV since the battery power is utilized to propel the UAV.

Current handover mechanisms are tailored for terrestrial communications. Communication devices operating during terrestrial communications tend not to change altitude while moving throughout the network and possible base station connections for the communication devices are less than those available to UAVs during operation. Accordingly, a new handover mechanism that optimizes handover procedures to reduce handover events during UAV operation may be beneficial.

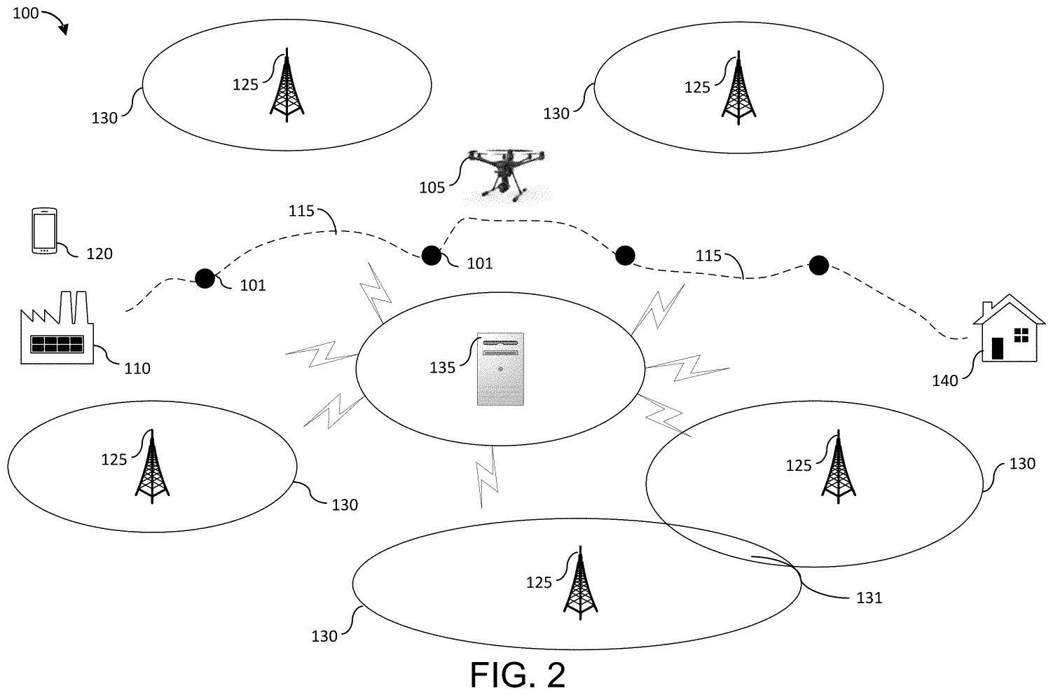

FIG. 2 illustrates an exemplary environment 100 in accordance with one or more embodiments of the present disclosure. The environment 100 may form at least a part of a cellular network (e.g., LTE, 5G, or another cellular network).

The environment 100 may include a UAV 105, an origination location 110, a destination location 140, a user device 120, base stations 125, and a UAV management system 135. The UAV 105, the origination location 110, the destination location 140, the user device 120, base stations 125, and the UAV management system 135 may be communicatively coupled to one another, directly or indirectly.

The UAV 105 may include a flight control unit (not shown), communication unit (not shown), and payload unit (not shown). The flight control unit may be configured to facilitate aerial navigation of the UAV 105 (e.g., take off, landing, and flight of the UAV 105). The flight control unit of the UAV 105 may include any appropriate avionics, control actuators, and/or other equipment, along with associated logic, circuitry, interfaces, memory, and/or code needed to facilitate aerial flight and navigation. For example, the flight control unit may include a global positioning system (GPS) that provides a current position of the UAV 105 (e.g., using three coordinates). The position information obtained from the GPS, together with position information of devices in communication with the UAV 105, may allow the UAV 105 to travel from the origination location 110 to the destination location 140. The UAV 105 may also include additional sensors (e.g., radar, altimeter, transponders, etc.). The UAV 105 may further include one or more cameras.

The communication unit may include one or more radio transceivers (e.g., antennas) along with associated hardware and software enabling communications with, for example, one or more devices located at the origination location 110, one or more devices located at the destination location 140, the user device 120, one or more of the base stations 125, and the UAV management system 135. The one or more radio transceivers of the UAV 105 may be an omnidirectional antenna or a directional antenna.

The UAV 105 may compute a signal strength for signals received by the one or more radio transceivers. A signal strength of signals received from base stations 125 may be based on, for example, a received signal strength indicator (RSSI), a reference signal received power (RSRP), a reference signal received quality (RSRQ), a signal-to-noise ratio (SNR), a signal-to-interference-plus-noise ratio (SINR), or other measures. A higher signal strength may generally be associated with better reception for the UAV 105. By facilitating establishing and maintaining of connections with a higher signal strength, the UAV 105 may facilitate implementation of various features supported by the UAV 105.

The payload unit may include one or more onboard sensors, which may be contained within a housing of the UAV 105 or mounted outside the housing of the UAV 105. The payload unit may additionally include tools, actuators, robotic manipulators, etc., capable of performing payload operations, such as securing, grasping, delivering, and/or measuring objects, which may be secured within or below a housing of the UAV 105.

The user device 120 may be, for example, a mobile phone, a personal digital assistant (PDA), a tablet device, a computer, or generally any device that is operable to communicate wirelessly with the UAV 105, one or more of the base stations 125, and the UAV management system 135. The user device 120 may be used as a remote control by an operator (e.g., a human or computer system) to provide commands to the UAV 105 when the UAV 105 is within line of sight of the user device 120. For example, the operator may issue commands via the user device 120 to instruct the UAV 105 to fly in certain directions, at certain speeds, or perform payload operations such as picking up or delivering an object. Line of sight of the user device 120 may refer to a coverage area 130 within which signals transmitted by the user device 120 to the UAV 105 via a base station 125 may be received by the UAV 105 with sufficient signal strength. In some cases, the sufficient signal strength may be a preset threshold level (e.g., SNR level), which may be set during a setup/calibration stage for associating the UAV 105 with the user device 120.

The one or more base stations 125 include suitable logic, circuitry, interfaces, memory, or code that enable communications, e.g. with the user device 120, one or more other base stations 125, or the UAV management system 135, via wireless interfaces and one or more radio transceivers (e.g., antennas). The one or more base stations 125 may be a 4G radio access network (RAN), a 4G LTE RAN, or a 5G RAN. The UAV 105 may connect the one or more base stations 125 via an associated RAN intelligent controller (MC). The MC may include a set of functions and interfaces that allow for increased optimizations through policy-driven closed loop automation.

The one or more base stations 125 may be macrocell base stations, microcell base stations, picocell base stations, femtocell base stations, or the like. A coverage area for the one or more base stations 125 may vary depending on the type of base station used and may be stored in a coverage map. The coverage area of a base station may also vary based on environmental aspects, altitudes, and frequency band. For example, a base station may have a smaller coverage area on a rainy day than the same base station on a sunny day due to the attenuation of signals by rain. The coverage area may vary based on altitude, which may result in different coverage areas at different altitudes. For example, a coverage area of a base station may be larger at UAV flight altitudes (e.g., 500 feet) than at lower altitudes (e.g., ground level), due to fewer obstructions blocking signals from base stations at UAV flight altitudes.

The UAV management system 135 may be a standalone component or a component of a core network of a telecommunications network for processing information from UAVs (e.g., UAV 105), user devices (e.g., user device 120), or base stations (e.g., base stations 125), and managing connections of the UAVs or user devices to the base stations. The UAV management system 135 may also enable communications with one or more of the base stations 125, one or more UAVs, one or more user devices 120, via wireless interfaces (e.g., an air interface) and utilize one or more radio transceivers. The UAV management system 135 may facilitate connectivity between UAVs (or other vehicles/devices at flight altitude) and base stations 125 or may facilitate connectivity of UAVs and user devices with the base stations 125.

The UAV management system 135 may be a server that generates or distributes information (e.g., flight route information, flight route updates, origination location information, destination location information, sensor data, position, obstacle, weather, emergency broadcast information or the like). The information may be sent to the user device 120 or base stations 125. The user device 120 or the base stations 125 may relay the information from the UAV management system 135 to the UAV 105 via the base stations 125. The UAV management system 135 may be in communication with one or more sources (e.g., sensors, meteorological services, or information services) that provide the UAV management system 135 with obstacle information, weather information, traffic information, emergency broadcast information, etc. The UAV management system 135 may then relay the information received from these sources to the UAV 105 via base stations 125.

The base stations 125 may be in communication with the UAV management system 135 through a backhaul network. The UAV management system 135 may be in direct communication with the one or more of the base stations 125 or in communication with the one or more of the base stations 125 through one or more intermediary base stations.

Each of the base stations 125 may store or otherwise have access to a neighbor list including neighboring relationships between a base station and other base stations. The neighbor list may be an automatic neighbor relation (ANR) table. Neighboring relationships may be based on measurement reports provided by UAVs (e.g., UAV 105), user devices (e.g., user device 120), or another measurement source. The measurement reports may include signal strengths (e.g., RSSI, RSRP, etc.) of signals generated by each of the base stations 125 that are received and measured by the provided the UAV 105 at a given position (e.g., altitude, azimuth, range, elevation from a point (e.g., eNB or gNB), etc.), which may be used to create a coverage map. The coverage map may indicate base station signal coverage boundaries for multiple base stations of a given area (e.g., city, state, country, or portion thereof) that may be altitude specific. The UAV management system 135 may generate the neighbor list based on signal strength statistics, such as RSRP or RSSI variances, average SNR, average SINR, or generally any other signal strength statistics computed based on one or more signals received or measured by UAVs or user devices. The neighbor list may be used to augment the coverage map.

The UAV management system 135 may determine signal strength statistics at different positions (e.g., altitudes) or different frequency bands for each base station 125 based on the measurement reports and information associated with the coverage map. The UAV management system 135 may determine preferred frequency bands to be utilized by the UAV 105 to connect to one or more base stations 125 when at various altitudes based on signal strength statistics and the coverage map.

The UAV management system 135 may include a flight plan sub-system for processing information in the coverage map, information received from UAVs (e.g., the UAV 105 or other aerial devices), information received from devices at or near ground level (e.g., the user device 120), or information received from base stations (e.g., the base stations 125). Flight beyond a line of sight of the UAV 105 may be facilitated via pre-programmed flight plans (e.g. one or more flight plans provided by the user device 120 or the UAV management system 135). The pre-programmed flight plans may be calculated at a central node locating with a core network of the telecommunications network (e.g., a Mobile Edge Compute (MEC), a Self-Organized Network (SON) or RAN Intelligent Controller (MC). An operator of the UAV 105 or user device 120 may select a pre-programmed flight plan from the pre-programmed flight plans to be utilized, which may be transmitted to the UAV management system 135.

The flight plan sub-system may generate and manage the pre-programmed flight plans for the UAVs using the coverage map. Each of the flight plans may include a flight route generated based on an origination location 110 and a destination location 140, as well as one or more flight rules that provide constraints on UAV operation during the flight route.

The flight route may be defined by a set of points or a path (e.g., point 101 or path 115) for the UAV 105. The flight route may be generated prior to the UAV 105 traveling from the origination location to the destination location. Each point 101 may be associated with a set of coordinates, such as longitude, latitude, altitude, or the like. For example, the origination location 110 may be a warehouse at which the UAV 105 is provided with a payload (e.g., a package) to be delivered and the destination location 140 (e.g., a customer's house, a post office or courier service office, or other destination from which the payload is to be routed to a customer).

The flight route may indicate changes in latitude, longitude, or altitude throughout the flight route traversed by the UAV 105 from the origination location 110 to the destination location 140, as shown in FIG. 2. The flight plan sub-system may determine that a shortest path between two base stations 125 may not be feasible (e.g., due to temporary or permanent obstacles). While the shortest path may be implemented in geographic areas in which air traffic is sparse, the shortest path may not be optimal for cases in which the air traffic is heavy with UAVs of different sizes, shapes, speeds, or applications. The flight plan sub-system may determine that the flight route should utilize a smoother route (e.g., fewer turns or fewer changes in altitude) but a longer route may be preferable to a shorter route for a UAV that is carrying a payload (e.g., customer package, fragile equipment, etc.), to reduce the probability of the payload being damaged. The flight plan sub-system may also determine battery/energy efficient flight path/route for the UAV which considers battery/energy drain per handover, UAV altitude, base stations, among other things.

The flight plans may be generated and managed to facilitate connectivity between the UAV 105, the user device 120 and base stations 125 devices, and facilitate flight of UAV 105 at multiple flight altitudes when the UAV 105 is within a coverage area of an associated base station 125. When generating and managing flight plans, the flight plan sub-system may utilize origination location information, delivery location information, coverage map information, traffic information, including air traffic information associated with UAVs connected to the telecommunications network, as well as receive other air traffic information not associated with the telecommunications networks provided by the UAVs, e.g., Federal Aviation Administration (FAA), which may be used to generate one or more flight rules. For example, the flight plan sub-system may consult and comply with FAA requirements or recommendations, including temporary flight restrictions (e.g., temporary event such as wildfire or security-related event, stadiums/sporting events), restricted airspace, airport-related restrictions, local flight ordinances, or others. Other flight recommendations or requirements may be taken into consideration, such as any recommended or required minimum/maximum flight altitude or minimum or maximum flight speed. Similarly, the flight rules may be utilized to cause the UAV 105 to maintain a minimum distance between the UAV 105 and other UAVs, or between the UAV 105 and obstacles. The flight plan sub-system may also receive air traffic information from other parties, such as other UAVs or crowdsourcing (e.g., users that provide air traffic information about particular locations or air traffic incidences) or other sources. The traffic information may include flight statistics associated with the base stations 125 or other base stations (e.g., signal strength statistics, such as RSRP or RSSI variances, average SNR, average SINR, or generally any other signal strength statistics).

The UAV 105 may utilize a directional antenna(s) or an omnidirectional antenna(s) while executing a flight plan. The UAV may utilize a directional antenna to determine characteristics (e.g., channel, signal strength, etc.) associated with base stations 125. The UAV 105 may utilize an omnidirectional antenna to locate base stations 125 to determine characteristics of the base stations 125 (e.g., longitude, latitude, or altitude of the base stations). The UAV 105 may also provide information, (e.g., a position, heading, or speed of the UAV, direction pointed at by a directional antenna (if applicable), or other characteristics associated with the UAV 105) to the UAV management system 135.

The UAV management system 135 may utilize the coverage map to retrieve information associated with the base stations 125 to identify a particular base station or request information from a particular base station. The information may be utilized to determine performance characteristics associated with the particular base station 125. The performance characteristics may include, for example, accessibility (e.g., radio resource control (RRC) setup success rates), mobility (e.g., handover success rates), utilization rates, occupancy rate information, or other characteristics. For example, the utilization rate or occupancy rate information may include a ratio of an average amount of data traffic associated with the base station to a capacity of the base station (e.g., amount of data traffic that can be supported at any given time by the base station). In some cases, the performance characteristics may also include key performance indicators (KPIs) (e.g., accessibility, retainability, integrity, availability, or mobility associated with a 3GPP standard). The performance characteristics may also be used to generate flight plans. MIMO beam-steering data from the eNodeB or gNodeB could also be used to generate and improve the altitude- or route-specific coverage map.

As illustrated in FIG. 2, some coverage areas 130 of the base stations 125 may overlap. The coverage areas 130 may represent the coverage areas of the base stations 125 at ground level. The UAV 105 may be within range of two or more of the base stations 125. The UAV 105 may be within a range of the base stations 125 in an overlap area 131. Based on a specific position of the UAV 105, a signal strength between the UAV 105 and the base station 125 may be different from (e.g., stronger than, weaker than) a signal strength between the UAV 105 and other base stations 125. In some cases, the overlap area 131 may vary in size and shape at flight altitudes than the overlap area 131 at ground level, such as due to fewer obstructions.

In addition to the flight route, the flight plan may include flight rules which may be used to traverse the flight route. The flight rules may facilitate the sharing of the airspace by the multiple UAVs or other aerial devices.

The flight rules may indicate which base stations the UAV 105 may utilize for connectivity to the telecommunications network while traversing the flight route. The flight plan information may include positions (e.g., in three dimensions) of each base station 125 used to traverse the flight route, frequencies which may be used to communicate with each base station, and other information used to connect the UAV 105 to each base station used to traverse the flight route.

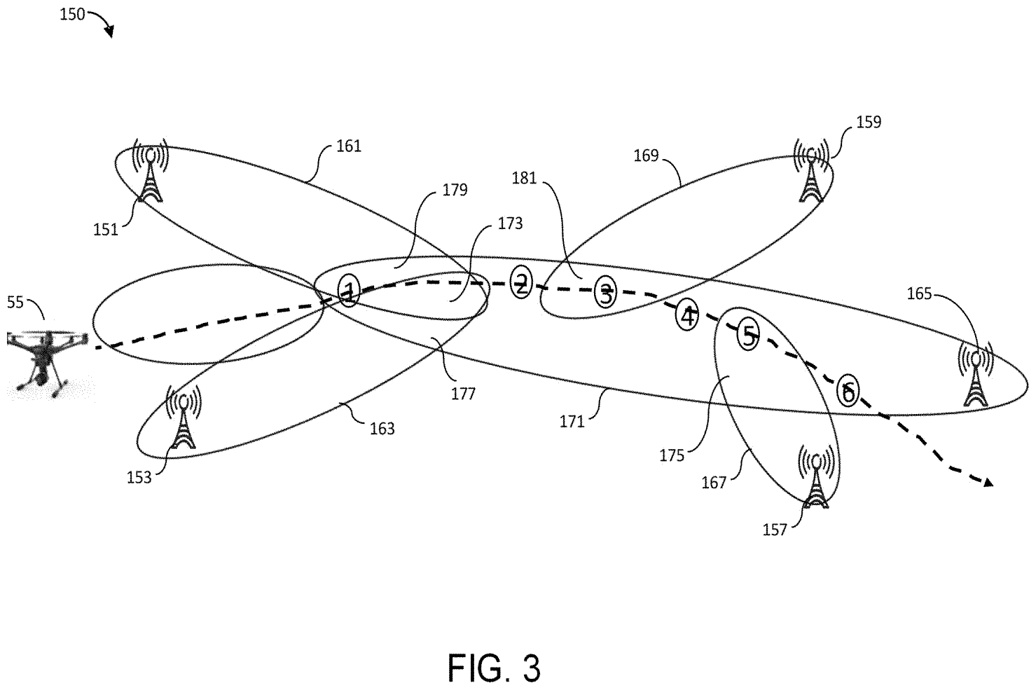

FIG. 3 illustrates an exemplary handover procedure 150 for UAV flight in accordance with one or more embodiments of the present disclosure. In preparation for a flight of UAV 155, receive a selected pre-programmed flight plan from, for example a UAV management system. The UAV 155 may be similar or identical to UAV 105. The pre-programed flight plan may be based on air traffic information of UAVs previously connected to base stations illustrated in FIG. 3 (e.g., base station 151, base station 153, base station 157, base station 159, etc.). The pre-programed flight plan may also utilize measurement reports, coverage maps developed from the measurement reports, and flight statistics associated with the base stations illustrated in FIG. 3.

The coverage map may include coverage areas (e.g. coverage area 161, coverage area 163, coverage area 171, coverage area 167, coverage area 169, etc.) of the base stations, as well as coverage area overlaps (e.g., overlap area 173, overlap area 175, overlap area 177, overlap area 179, overlap area 181, etc.) encountered during a flight route indicated in the pre-programmed flight plan. The pre-programmed flight plan may indicate changes in speed, latitude, longitude, and altitude throughout the flight route traversed by the UAV 155 from an origination location to a destination location. The pre-programed flight plan may include positions of each base station used to traverse the flight route, frequencies which may be used to communicate with each base station, and other information used to connect the UAV 155 to each base station used to traverse the flight route.

The pre-programed flight plan may also include flight rules used by the UAV 155 while traversing the flight route. The flight rules may be used to control UAV 155 operation during a handover procedure used to switch connectivity from one base station to another base station when traversing the flight route. Handovers may be based on signal strength statistics of base stations that may be encountered during a flight route including coverage area overlaps that may occur along the flight route. The flight rules may utilize an estimate of a number of potential handover events (e.g., encountering one or more overlap areas) that may be possibly performed by the UAV 155 while traversing the flight route. The number of potential handover events may be in consideration of a signal strength of one or more base stations received by the UAV 155 at a given location and altitude. The flight rules may also include an estimate a quality of experience (QoE) for the UAV 155 based on, for example an RSRP Time Series, that reflects a time period the UAV 155 may be connected to a given base station while traversing the flight route. For example, the QoE estimate of an interaction with one or more base stations (e.g., base station 151, base station 153, base station 165, etc.) may indicate that base station 151 may have an excellent QoE but based on the associated coverage area of base station 151 may serve as an anchor base station for 20% of a flight trajectory (e.g., flight route), while the QoE estimate may indicate that base station 153 may have an good QoE but based on the associated coverage area of base station 153 may serve as an anchor base station for 30% of a flight trajectory, while the QoE estimate may indicate that base station 165 may have an acceptable QoE but based on the associated coverage area of base station 165 may serve as an anchor base station for 80% of a flight trajectory.

The flight rules may utilize an s-measure value (e.g., −100 dBm as a starting value) calculated by the UAV management system 135, which may be used to control one or more handovers performed by the UAV 155 while traversing the flight route. Each of the one or more handovers may be a blind handover (e.g., a handover that was not triggered by the UAV 155). The s-measure value may be a standard applied by all UAVs that connect to the given base station indicating a signal strength value of a signal to a given base station. The s-measure may be compared to an RSRP for the given base station. If the RSRP is less than the signal strength value (e.g., RSRP<s-measure), the signal strength to the given base station falls below a signal strength capable of maintaining connectivity between the UAV 155 and the given base station.

When the UAV 155 traverses the flight route including a plurality of locations (e.g., location 1, location 2, location 3, location 4, location 5, and location 6), the flight rules may cause the UAV 155 perform a handover or otherwise cause the UAV 155 to be connected to a selected base station (e.g., an anchor base station). For example, the flight rules may take into consideration overlap areas 173, 177, and 179 when the UAV 155 travels from location 1 to location 2, as well as an s-measure value for each base station having a coverage area encompassing location 1 and location 2 to determine a preferred connectivity to a selected base station (e.g., base station 165), which may serve as an initial anchor base station during a first handover. The selected base station may be selected because the s-measure value associated with the selected base station is above a variable s-measure value threshold. When selecting the anchor base station at a first overlap area (e.g., location 1), the variable s-measure value threshold may be set to a high s-measure threshold value (e.g., −100 dBm) in order to select an anchor base station (e.g., base station 165) at location 1. The higher an s-measure value, a potential of dropping connectivity between the UAV 155 and the anchor base station increases; however, more base stations associated with an overlap area may be considered when selecting an initial anchor base station.

Accordingly, the flight rules may force (e.g., instruct) connectivity to base station 165, the anchor base station, and prevent the UAV 155 from connecting to base station 151 or base station 153 while traversing from location 1 to location 2, even though base station 151 or base station 153 may have a higher signal strength than base station 165 when the UAV 155 is at or near location 1 or location 2. The selection of the initial anchor base station 165 may be in consideration of the entire flight route, coverage areas of each base station that may be encountered along the flight route, and signal strength for each base station at a given location and altitude along the flight route. Once base station 165 has been selected as the anchor base station, the UAV management system 135 may adjust the flight rules to reduce the variable s-measure value threshold in order to maintain connectivity to the anchor base station throughout the flight route or portion thereof (e.g., location 3, location 4, location 5, and location 6).

The flight rules may further indicate whether further handovers should occur or whether the initial anchor base station should remain the anchor base station for subsequent locations. For example, because the coverage area 171 of base station 165 encompasses location 3, location 4, location 5, and location 6, the flight rules may cause the UAV 155 to maintain a connection with the base station 165. By using base station 165 as the anchor base station when traveling from location 1 to location 6, multiple handovers are prevented thereby preventing an amount of battery utilization needed to conduct a handover, as well as reducing signaling overhead needed for communication with the base stations and the UAV management system 135 during a handover.

Accordingly, the anchor base station (e.g., base station 165) may serve as a base station that may connect to the UAV 155 for a longer period of time than would occur normally (e.g., where a handover would normally occur due to an additional base station in an overlapping coverage having a higher signal strength) while the UAV 155 is traversing the flight route. Depending on a distance from an origination location to a destination location, traffic information, or other air traffic information, the UAV management system 135 may send a flight plan that includes more than one anchor base station for use by the UAV 155 while traversing the flight route. By reducing the number of handovers by the UAV 155, performance of the UAV 155 is optimized, and network resources otherwise used during handovers are not needed and may be used for other network operations.

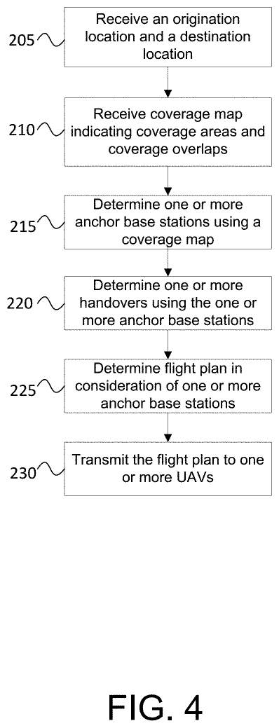

FIG. 4 illustrates a method of determining handovers while traversing a flight route according one or more embodiments. At block 205, a UAV management system 135 may receive an origination location for a UAV and a destination location the UAV is expected to travel to in order to perform a designated action (e.g., pickup, delivery, notification, etc.). At block 210, the UAV management system 135 may receive or generate a coverage map indicating coverage areas and coverage overlaps for one or more base stations that may be possibly used by the UAV to travel from the origination location to the destination location. At block 215, the UAV management system 135 may determine one or more base stations to serve as one or more anchor base stations for the UAV when the UAV travels from the origination location to the destination location using the coverage map. At block 220, the UAV management system 135 may determine one or more locations where a handover should be performed in light of the one or more anchor base stations determined.

At block 225, the UAV management system 135 may determine a flight plan including a flight route and one or more flight rules for operating the UAV traveling from the origination location to the destination location using the one or more anchor base stations. At block 230, the UAV management system 135 may send the flight plan to the UAV.

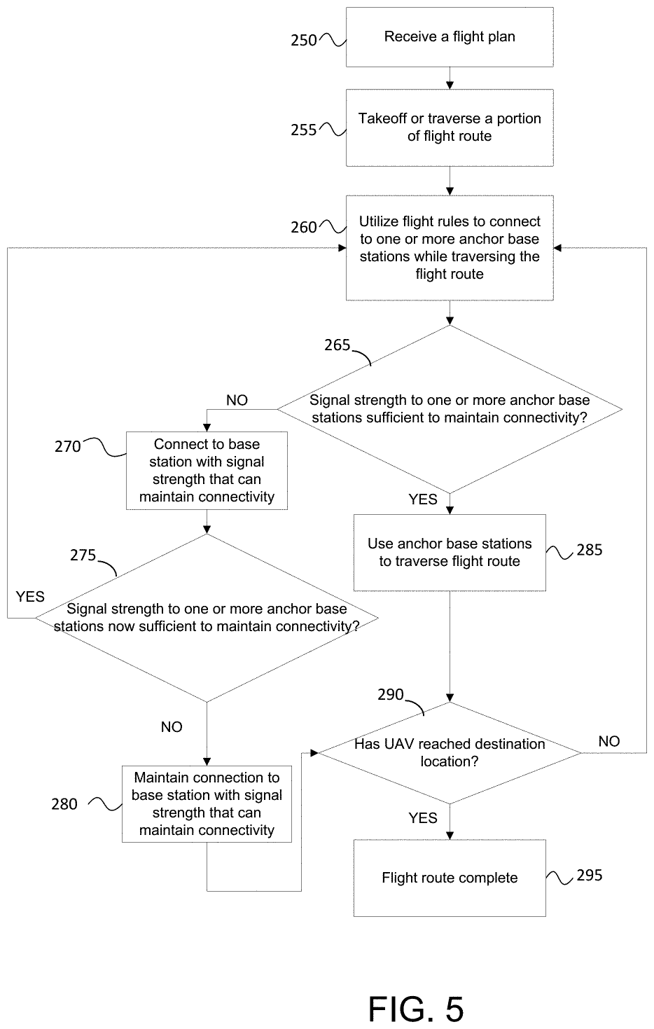

FIG. 5 illustrates a method of performing handovers while traversing a flight route according one or more embodiments. At block 250, a UAV may receive a flight plan including a flight route and one or more flight rules from a UAV management system 135, a user device 120, or an external system (e.g., a delivery management system). At block 255, the UAV may traverse a portion of the flight route (e.g., takeoff). At block 260, the UAV may operate using the one or more flight rules while traversing the flight route which may cause the UAV to connect to one or more anchor base stations, even in instances where the UAV is receiving signals from another base station having a higher signal strength. At block 265, while traversing the flight route using the flight rules, the UAV may determine whether a signal strength capable of maintaining connectivity to one or more anchor base stations in the flight plan is correct. At block 270, if the signal strength is not capable of maintaining connectivity to one or more anchor stations, the UAV may perform a handover to a base station which the UAV is capable of maintaining connectivity. At block 275, the UAV may determine whether a signal strength capable of maintaining connectivity to one or more anchor base stations can be re-established. IF connectivity to the one or more base stations can be re-established, the method returns to block 260. At block 280, if the signal strength is still not capable of maintaining connectivity to one or more anchor stations, the UAV may continue to utilize the current base station connected or perform another handover. The method then proceeds to block 290.

At block 285, if the signal strength is capable of maintaining connectivity to one or more anchor stations, the UAV may continue to utilize the one or more anchor stations. At block 290, the UAV may determine whether the destination location has been reached or may receive a communication from the destination location indicating that the UAV has reached the destination location. If the UAV has reached the destination location, at block 295, the flight route is complete. If the UAV has not reached the destination location, the method returns to block 260.

Accordingly, the present disclosure provides a system that may optimize handover procedures for UAVs while traversing a telecommunications network that may reduce unnecessary handover events. The handover procedure may instruct the UAV to attach to the at least one anchor base station despite other base stations having a higher signal strength. Accordingly, the handover procedure may preserve battery power, which would otherwise be used for handovers, to be used to propel the UAV or implement one or more functions associated with UAV (e.g., operate a camera, sensors, tools, actuators, robotic manipulators, etc.) .

The present disclosure provides a methodology for optimizing handover procedure for UAVs, which may be stored at a central node global control located on the Core Network, (e.g., Mobile Edge Compute (MEC), Self-Organized Network (SON) or RAN Intelligent Controller (RIC)). The methodology may utilize traffic management policies being implemented in the network. The methodology may detect that a UAV is flying through a terrestrial 4G/5G network, then estimate a trajectory for the UAV and propose a long lasting anchor cell (e.g., an anchor base station). The long lasting anchor may be a base station that is most likely to be detected by the UAV for a longer period of time when is traveling through the network in order to reduce the number of handovers when traveling through the network. The methodology may identify a most suitable long lasting anchor for the UAV based on measuring and reporting. The methodology may instruct the UAV to attach to the long lasting anchor. Forcing a handover may be accomplished using a blind handover. The methodology may select a long lasting anchor for the UAV depending on its trajectory and a network topology. The UAV may switch long lasting anchors or switch to other base stations during its route, which may be a predefined route. The methodology may estimate an RSRP time series for each of the base stations in a coverage map that may be used in a flight route from a current location to a destination. The methodology may further estimate a number of handover events that may occur when the UAV traverses the flight route in consideration of a selected a long_lasting_anchor as a function of an associated s-measure. The methodology may further estimate a quality of experience for the UAV based on the RSRP time series during the time that the UAV is connected to the long_lasting_anchor, which may be contrasted against the UAV's quality of service requirements. The methodology may further keep track of when the UAV travels out of coverage of the long-lasting-anchor and estimate how close the UAV flight route trajectory was to a middle of a beam based on its trajectory, which may be used to predict a coverage of the long-lasting-anchor for subsequent UAVs that enter coverage for this long-lasting-anchor.

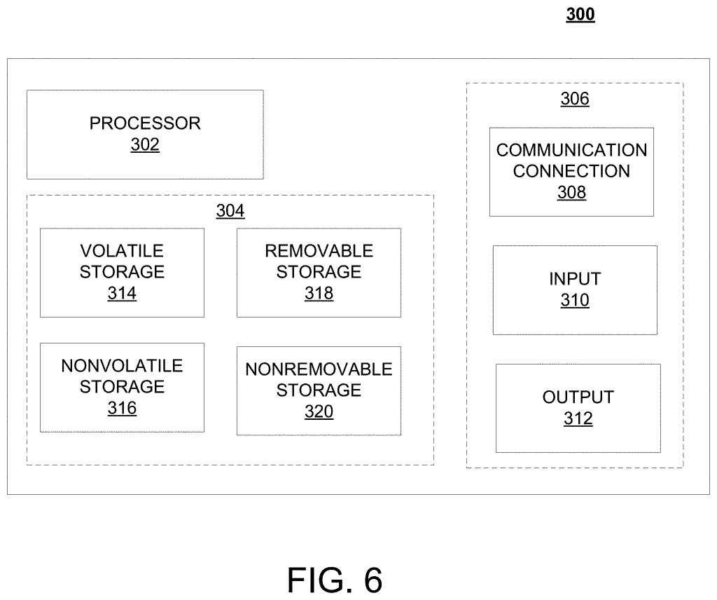

FIG. 6 is a block diagram of network device 300 that may be connected to or comprise a component of edge computing node or connected to edge computing node via a network. Network device 300 may comprise hardware or a combination of hardware and software. The functionality to facilitate telecommunications via a telecommunications network may reside in one or combination of network devices 300. Network device 300 depicted in FIG. 6 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an ALFS, a gateway mobile location center (GMLC), a radio access network (RAN), a serving mobile location center (SMLC), or the like, or any appropriate combination thereof. It is emphasized that the block diagram depicted in FIG. 6 is exemplary and not intended to imply a limitation to a specific implementation or configuration. Thus, network device 300 may be implemented in a single device or multiple devices (e.g., single server or multiple servers, single gateway or multiple gateways, single controller, or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 6) to allow communications therebetween. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a nonremovable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

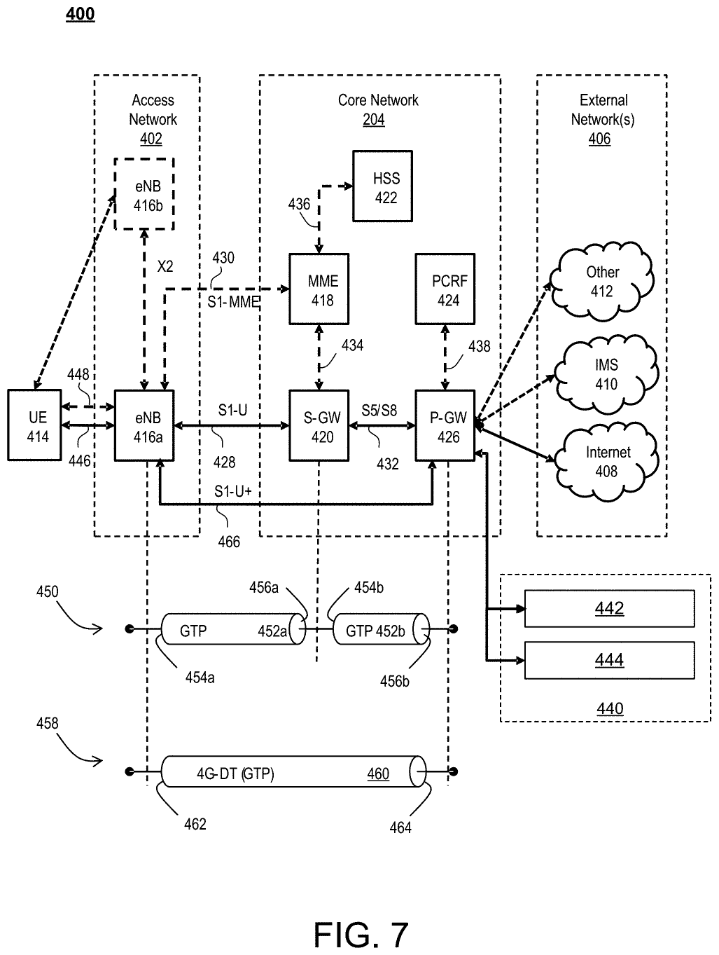

FIG. 7 illustrates a functional block diagram depicting one example of an LTE-EPS network architecture 400 related to the current disclosure. In particular, the network architecture 400 disclosed herein is referred to as a modified LTE-EPS architecture 400 to distinguish it from a traditional LTE-EPS architecture.

An example modified LTE-EPS architecture 400 is based at least in part on standards developed by the 3rd Generation Partnership Project (3GPP), with information available at www.3gpp.org. In one embodiment, the LTE-EPS network architecture 400 includes an access network 402, a core network 404, e.g., an EPC or Common BackBone (CBB) and one or more external networks 406, sometimes referred to as PDN or peer entities. Different external networks 406 can be distinguished from each other by a respective network identifier, e.g., a label according to DNS naming conventions describing an access point to the PDN. Such labels can be referred to as Access Point Names (APN). External networks 406 can include one or more trusted and non-trusted external networks such as an internet protocol (IP) network 408, an IP multimedia subsystem (IMS) network 410, and other networks 412, such as a service network, a corporate network, or the like.

Access network 402 can include an LTE network architecture sometimes referred to as Evolved Universal mobile Telecommunication system Terrestrial Radio Access (E UTRA) and evolved UMTS Terrestrial Radio Access Network (E-UTRAN). Broadly, access network 402 can include one or more communication devices, commonly referred to as UE 414, and one or more wireless access nodes, or base stations 416a, 416b. During network operations, at least one base station 416 communicates directly with UE 414. Base station 416 can be an evolved Node B (eNodeB), with which UE 414 communicates over the air and wirelessly. UEs 414 can include, without limitation, wireless devices, e.g., satellite communication systems, portable digital assistants (PDAs), laptop computers, tablet devices, Internet-of-things (IoT) devices, and other mobile devices (e.g., cellular telephones, smart appliances, and so on). UEs 414 can connect to eNBs 416 when UE 414 is within range according to a corresponding wireless communication technology.

UE 414 generally runs one or more applications that engage in a transfer of packets between UE 414 and one or more external networks 406. Such packet transfers can include one of downlink packet transfers from external network 406 to UE 414, uplink packet transfers from UE 414 to external network 406 or combinations of uplink and downlink packet transfers. Applications can include, without limitation, web browsing, VoIP, streaming media, and the like. Each application can pose different Quality of Service (QoS) requirements on a respective packet transfer. Different packet transfers can be served by different bearers within core network 404, e.g., according to parameters, such as the QoS.

Core network 404 uses a concept of bearers, e.g., EPS bearers, to route packets, e.g., IP traffic, between a particular gateway in core network 404 and UE 414. A bearer refers generally to an IP packet flow with a defined QoS between the particular gateway and UE 414. Access network 402, e.g., E UTRAN, and core network 404 together set up and release bearers as required by the various applications. Bearers can be classified in at least two different categories: (i) minimum guaranteed bit rate bearers, e.g., for applications, such as VoIP; and (ii) non-guaranteed bit rate bearers that do not require guarantee bit rate, e.g., for applications, such as web browsing.

In one embodiment, the core network 404 includes various network entities, such as MME 418, SGW 420, Home Subscriber Server (HSS) 422, Policy and Charging Rules Function (PCRF) 424 and PGW 426. In one embodiment, MME 418 comprises a control node performing a control signaling between various equipment and devices in access network 402 and core network 404. The protocols running between UE 414 and core network 404 are generally known as Non-Access Stratum (NAS) protocols.

For illustration purposes only, the terms MME 418, SGW 420, HSS 422 and PGW 426, and so on, can be server devices, but may be referred to in the subject disclosure without the word “server.” It is also understood that any form of such servers can operate in a device, system, component, or other form of centralized or distributed hardware and software. It is further noted that these terms and other terms such as bearer paths or interfaces are terms that can include features, methodologies, or fields that may be described in whole or in part by standards bodies such as the 3GPP. It is further noted that some or all embodiments of the subject disclosure may in whole or in part modify, supplement, or otherwise supersede final or proposed standards published and promulgated by 3GPP.

According to traditional implementations of LTE-EPS architectures, SGW 420 routes and forwards all user data packets. SGW 420 also acts as a mobility anchor for user plane operation during handovers between base stations, e.g., during a handover from first eNB 416a to second eNB 416b as may be the result of UE 414 moving from one area of coverage, e.g., cell, to another. SGW 420 can also terminate a downlink data path, e.g., from external network 406 to UE 414 in an idle state and trigger a paging operation when downlink data arrives for UE 414. SGW 420 can also be configured to manage and store a context for UE 414, e.g., including one or more of parameters of the IP bearer service and network internal routing information. In addition, SGW 420 can perform administrative functions, e.g., in a visited network, such as collecting information for charging (e.g., the volume of data sent to or received from the user), or replicate user traffic, e.g., to support a lawful interception. SGW 420 also serves as the mobility anchor for interworking with other 3GPP technologies such as universal mobile telecommunication system (UMTS).

At any given time, UE 414 is generally in one of three different states: detached, idle, or active. The detached state is typically a transitory state in which UE 414 is powered on but is engaged in a process of searching and registering with network 402. In the active state, UE 414 is registered with access network 402 and has established a wireless connection, e.g., radio resource control (RRC) connection, with eNB 416. Whether UE 414 is in an active state can depend on the state of a packet data session, and whether there is an active packet data session. In the idle state, UE 414 is generally in a power conservation state in which UE 414 typically does not communicate packets. When UE 414 is idle, SGW 420 can terminate a downlink data path, e.g., from one peer entity 406, and triggers paging of UE 414 when data arrives for UE 414. If UE 414 responds to the page, SGW 420 can forward the IP packet to eNB 416a.

HSS 422 can manage subscription-related information for a user of UE 414. For example, HSS 422 can store information such as authorization of the user, security requirements for the user, quality of service (QoS) requirements for the user, etc. HSS 422 can also hold information about external networks 406 to which the user can connect, e.g., in the form of an APN of external networks 406. For example, MME 418 can communicate with HSS 422 to determine if UE 414 is authorized to establish a call, e.g., a voice over IP (VoIP) call before the call is established.

PCRF 424 can perform QoS management functions and policy control. PCRF 424 is responsible for policy control decision-making, as well as for controlling the flow-based charging functionalities in a policy control enforcement function (PCEF), which resides in PGW 426. PCRF 424 provides the QoS authorization, e.g., QoS class identifier and bit rates that decide how a certain data flow will be treated in the PCEF and ensures that this is in accordance with the user's subscription profile.

PGW 426 can provide connectivity between the UE 414 and one or more of the external networks 406. In illustrative network architecture 400, PGW 426 can be responsible for IP address allocation for UE 414, as well as one or more of QoS enforcement and flow-based charging, e.g., according to rules from the PCRF 424. PGW 426 is also typically responsible for filtering downlink user IP packets into the different QoS-based bearers. In at least some embodiments, such filtering can be performed based on traffic flow templates. PGW 426 can also perform QoS enforcement, e.g., for guaranteed bit rate bearers. PGW 426 also serves as a mobility anchor for interworking with non-3GPP technologies such as CDMA2000.

Within access network 402 and core network 404 there may be various bearer paths/interfaces, e.g., represented by solid lines 428 and 430. Some of the bearer paths can be referred to by a specific label. For example, solid line 428 can be considered an S1-U bearer and solid line 432 can be considered an S5/S8 bearer according to LTE-EPS architecture standards. Without limitation, reference to various interfaces, such as S1, X2, S5, S8, S11 refer to EPS interfaces. In some instances, such interface designations are combined with a suffix, e.g., a “U” or a “C” to signify whether the interface relates to a “User plane” or a “Control plane.” In addition, the core network 404 can include various signaling bearer paths/interfaces, e.g., control plane paths/interfaces represented by dashed lines 430, 434, 436, and 438. Some of the signaling bearer paths may be referred to by a specific label. For example, dashed line 430 can be considered as an S1-MME signaling bearer, dashed line 434 can be considered as an S11 signaling bearer and dashed line 436 can be considered as an Sha signaling bearer, e.g., according to LTE-EPS architecture standards. The above bearer paths and signaling bearer paths are only illustrated as examples and it should be noted that additional bearer paths and signaling bearer paths may exist that are not illustrated.

Also shown is a novel user plane path/interface, referred to as the S1-U+ interface 466. In the illustrative example, the S1-U+ user plane interface extends between the eNB 416a and PGW 426. Notably, S1-U+ path/interface does not include SGW 420, a node that is otherwise instrumental in configuring or managing packet forwarding between eNB 416a and one or more external networks 406 by way of PGW 426. As disclosed herein, the S1-U+ path/interface facilitates autonomous learning of peer transport layer addresses by one or more of the network nodes to facilitate a self-configuring of the packet forwarding path. In particular, such self-configuring can be accomplished during handovers in most scenarios so as to reduce any extra signaling load on the S/PGWs 420, 426 due to excessive handover events.

In some embodiments, PGW 426 is coupled to storage device 440, shown in phantom. Storage device 440 can be integral to one of the network nodes, such as PGW 426, for example, in the form of internal memory or disk drive. It is understood that storage device 440 can include registers suitable for storing address values. Alternatively or in addition, storage device 440 can be separate from PGW 426, for example, as an external hard drive, a flash drive, or network storage.

Storage device 440 selectively stores one or more values relevant to the forwarding of packet data. For example, storage device 440 can store identities or addresses of network entities, such as any of network nodes 418, 420, 422, 424, and 426, eNBs 416 or UE 414. In the illustrative example, storage device 440 includes a first storage location 442 and a second storage location 444. First storage location 442 can be dedicated to storing a Currently Used Downlink address value 442. Likewise, second storage location 444 can be dedicated to storing a Default Downlink Forwarding address value 444. PGW 426 can read or write values into either of storage locations 442, 444, for example, managing Currently Used Downlink Forwarding address value 442 and Default Downlink Forwarding address value 444 as disclosed herein.

In some embodiments, the Default Downlink Forwarding address for each EPS bearer is the SGW S5-U address for each EPS Bearer. The Currently Used Downlink Forwarding address' for each EPS bearer in PGW 426 can be set every time when PGW 426 receives an uplink packet, e.g., a GTP-U uplink packet, with a new source address for a corresponding EPS bearer. When UE 414 is in an idle state, the “Current Used Downlink Forwarding address” field for each EPS bearer of UE 414 can be set to a “null” or other suitable value.

In some embodiments, the Default Downlink Forwarding address is only updated when PGW 426 receives a new SGW S5-U address in a predetermined message or messages. For example, the Default Downlink Forwarding address is only updated when PGW 426 receives one of a Create Session Request, Modify Bearer Request and Create Bearer Response messages from SGW 420.

As values 442, 444 can be maintained and otherwise manipulated on a per bearer basis, it is understood that the storage locations can take the form of tables, spreadsheets, lists, or other data structures generally well understood and suitable for maintaining or otherwise manipulate forwarding addresses on a per bearer basis.

It should be noted that access network 402 and core network 404 are illustrated in a simplified block diagram in FIG. 7. In other words, either or both of access network 402 and the core network 404 can include additional network elements that are not shown, such as various routers, switches, and controllers. In addition, although FIG. 7 illustrates only a single one of each of the various network elements, it should be noted that access network 402 and core network 404 can include any number of the various network elements. For example, core network 404 can include a pool (i.e., more than one) of MMEs 418, SGWs 420 or PGWs 426.

In the illustrative example, data traversing a network path between UE 414, eNB 416a, SGW 420, PGW 426 and external network 406 may be considered to constitute data transferred according to an end-to-end IP service. However, for the present disclosure, to properly perform establishment management in LTE-EPS network architecture 400, the core network, data bearer portion of the end-to-end IP service is analyzed.

An establishment may be defined herein as a connection set up request between any two elements within LTE-EPS network architecture 400. The connection set up request may be for user data or for signaling. A failed establishment may be defined as a connection set up request that was unsuccessful. A successful establishment may be defined as a connection set up request that was successful.

In one embodiment, a data bearer portion comprises a first portion (e.g., a data radio bearer 446) between UE 414 and eNB 416a, a second portion (e.g., an S1 data bearer 428) between eNB 416a and SGW 420, and a third portion (e.g., an S5/S8 bearer 432) between SGW 420 and PGW 426. Various signaling bearer portions are also illustrated in FIG. 7. For example, a first signaling portion (e.g., a signaling radio bearer 448) between UE 414 and eNB 416a, and a second signaling portion (e.g., Sl signaling bearer 430) between eNB 416a and MME 418.

In at least some embodiments, the data bearer can include tunneling, e.g., IP tunneling, by which data packets can be forwarded in an encapsulated manner, between tunnel endpoints. Tunnels, or tunnel connections can be identified in one or more nodes of network 400, e.g., by one or more of tunnel endpoint identifiers, an IP address, and a user datagram protocol port number. Within a particular tunnel connection, payloads, e.g., packet data, which may or may not include protocol related information, are forwarded between tunnel endpoints.

An example of first tunnel solution 450 includes a first tunnel 452a between two tunnel endpoints 454a and 456a, and a second tunnel 452b between two tunnel endpoints 454b and 456b. In the illustrative example, first tunnel 452a is established between eNB 416a and SGW 420. Accordingly, first tunnel 452a includes a first tunnel endpoint 454a corresponding to an S1-U address of eNB 416a (referred to herein as the eNB S1-U address), and second tunnel endpoint 456a corresponding to an S1-U address of SGW 420 (referred to herein as the SGW S1-U address). Likewise, second tunnel 452b includes first tunnel endpoint 454b corresponding to an S5-U address of SGW 420 (referred to herein as the SGW S5-U address), and second tunnel endpoint 456b corresponding to an S5-U address of PGW 426 (referred to herein as the PGW S5-U address).

In at least some embodiments, first tunnel solution 450 is referred to as a two-tunnel solution, e.g., according to the GPRS Tunneling Protocol User Plane (GTPvl-U based), as described in 3GPP specification TS 29.281, incorporated herein in its entirety. It is understood that one or more tunnels are permitted between each set of tunnel end points. For example, each subscriber can have one or more tunnels, e.g., one for each PDP context that they have active, as well as possibly having separate tunnels for specific connections with different quality of service requirements, and so on.

An example of second tunnel solution 458 includes a single or direct tunnel 460 between tunnel endpoints 462 and 464. In the illustrative example, direct tunnel 460 is established between eNB 416a and PGW 426, without subjecting packet transfers to processing related to SGW 420. Accordingly, direct tunnel 460 includes first tunnel endpoint 462 corresponding to the eNB S1-U address, and second tunnel endpoint 464 corresponding to the PGW S5-U address. Packet data received at either end can be encapsulated into a payload and directed to the corresponding address of the other end of the tunnel. Such direct tunneling avoids processing, e.g., by SGW 420 that would otherwise relay packets between the same two endpoints, e.g., according to a protocol, such as the GTP-U protocol.

In some scenarios, direct tunneling solution 458 can forward user plane data packets between eNB 416a and PGW 426, by way of SGW 420. For example, SGW 420 can serve a relay function, by relaying packets between two tunnel endpoints 416a, 426. In other scenarios, direct tunneling solution 458 can forward user data packets between eNB 416a and PGW 426, by way of the S1 U+ interface, thereby bypassing SGW 420.

Generally, UE 414 can have one or more bearers at any one time. The number and types of bearers can depend on applications, default requirements, and so on. It is understood that the techniques disclosed herein, including the configuration, management and use of various tunnel solutions 450, 458, can be applied to the bearers on an individual basis. For example, if user data packets of one bearer, say a bearer associated with a VoIP service of UE 414, then the forwarding of all packets of that bearer are handled in a similar manner. Continuing with this example, the same UE 414 can have another bearer associated with it through the same eNB 416a. This other bearer, for example, can be associated with a relatively low rate data session forwarding user data packets through core network 404 simultaneously with the first bearer. Likewise, the user data packets of the other bearer are also handled in a similar manner, without necessarily following a forwarding path or solution of the first bearer. Thus, one of the bearers may be forwarded through direct tunnel 458; whereas, another one of the bearers may be forwarded through a two-tunnel solution 450.

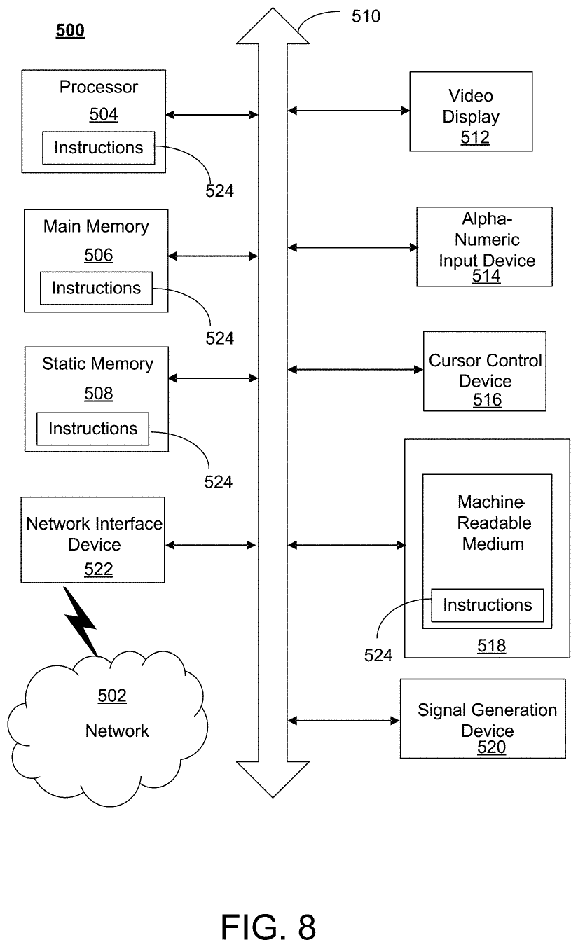

FIG. 8 depicts an exemplary diagrammatic representation of a machine in the form of a computer system 500 within which a set of instructions, when executed, may cause the machine to perform any one or more of the methods described above. One or more instances of the machine can operate, for example, as processor 302, UE 414, eNB 416, MME 418, SGW 420, HSS 422, PCRF 424, PGW 426 and other devices of FIGS. 1-3. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video, or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid-state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

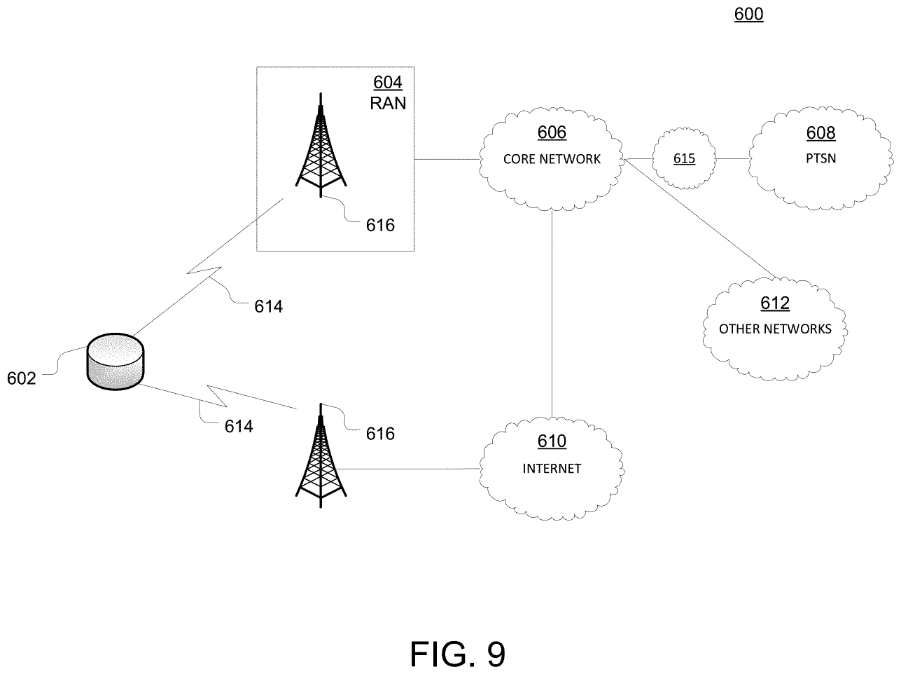

As shown in FIG. 9, telecommunication system 600 may include wireless transmit/receive units (WTRUs) 602, a RAN 604, a core network 606, a public switched telephone network (PSTN) 608, the Internet 610, or other networks 612, though it will be appreciated that the disclosed examples contemplate any number of WTRUs, base stations, networks, or network elements. Each WTRU 602 may be any type of device configured to operate or communicate in a wireless environment. For example, a WTRU may comprise IoT devices 32, mobile devices 33, network device 300, or the like, or any combination thereof. By way of example, WTRUs 602 may be configured to transmit or receive wireless signals and may include a UE, a mobile station, a mobile device, a fixed or mobile subscriber unit, a pager, a cellular telephone, a PDA, a smartphone, a laptop, a netbook, a personal computer, a wireless sensor, consumer electronics, or the like. WTRUs 602 may be configured to transmit or receive wireless signals over an air interface 614.

Telecommunication system 600 may also include one or more base stations 616. Each of base stations 616 may be any type of device configured to wirelessly interface with at least one of the WTRUs 602 to facilitate access to one or more communication networks, such as core network 606, PTSN 608, Internet 610, or other networks 612. By way of example, base stations 616 may be a base transceiver station (BTS), a Node-B, an eNodeB, a Home Node B, a Home eNodeB, a site controller, an access point (AP), a wireless router, or the like. While base stations 616 are each depicted as a single element, it will be appreciated that base stations 616 may include any number of interconnected base stations or network elements.

RAN 604 may include one or more base stations 616, along with other network elements (not shown), such as a base station controller (BSC), a radio network controller (RNC), or relay nodes. One or more base stations 616 may be configured to transmit or receive wireless signals within a particular geographic region, which may be referred to as a cell (not shown). The cell may further be divided into cell sectors. For example, the cell associated with base station 616 may be divided into three sectors such that base station 616 may include three transceivers: one for each sector of the cell. In another example, base station 616 may employ multiple-input multiple-output (MIMO) technology and, therefore, may utilize multiple transceivers for each sector of the cell.

Base stations 616 may communicate with one or more of WTRUs 602 over air interface 614, which may be any suitable wireless communication link (e.g., RF, microwave, infrared (IR), ultraviolet (UV), or visible light). Air interface 614 may be established using any suitable radio access technology (RAT).

More specifically, as noted above, telecommunication system 600 may be a multiple access system and may employ one or more channel access schemes, such as CDMA, TDMA, FDMA, OFDMA, SC-FDMA, or the like. For example, base station 616 in RAN 604 and WTRUs 602 connected to RAN 604 may implement a radio technology such as Universal Mobile Telecommunications System (UMTS) Terrestrial Radio Access (UTRA) that may establish air interface 614 using wideband CDMA (WCDMA). WCDMA may include communication protocols, such as High-Speed Packet Access (HSPA) or Evolved HSPA (HSPA+). HSPA may include High-Speed Downlink Packet Access (HSDPA) or High-Speed Uplink Packet Access (HSUPA).

As another example base station 616 and WTRUs 602 that are connected to RAN 604 may implement a radio technology such as Evolved UMTS Terrestrial Radio Access (E-UTRA), which may establish air interface 614 using LTE or LTE-Advanced (LTE-A).

Optionally base station 616 and WTRUs 602 connected to RAN 604 may implement radio technologies such as IEEE 602.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), GSM, Enhanced Data rates for GSM Evolution (EDGE), GSM EDGE (GERAN), or the like.

Base station 616 may be a wireless router, Home Node B, Home eNodeB, or access point, for example, and may utilize any suitable RAT for facilitating wireless connectivity in a localized area, such as a place of business, a home, a vehicle, a campus, or the like. For example, base station 616 and associated WTRUs 602 may implement a radio technology such as IEEE 602.11 to establish a wireless local area network (WLAN). As another example, base station 616 and associated WTRUs 602 may implement a radio technology such as IEEE 602.15 to establish a wireless personal area network (WPAN). In yet another example, base station 616 and associated WTRUs 602 may utilize a cellular-based RAT (e.g., WCDMA, CDMA2000, GSM, LTE, LTE-A, etc.) to establish a picocell or femtocell. As shown in FIG. 9, base station 616 may have a direct connection to Internet 610. Thus, base station 616 may not be required to access Internet 610 via core network 606.

RAN 604 may be in communication with core network 606, which may be any type of network configured to provide voice, data, applications, or voice over internet protocol (VoIP) services to one or more WTRUs 602. For example, core network 606 may provide call control, billing services, mobile location-based services, pre-paid calling, Internet connectivity, video distribution or high-level security functions, such as user authentication. Although not shown in FIG. 9, it will be appreciated that RAN 604 or core network 606 may be in direct or indirect communication with other RANs that employ the same RAT as RAN 604 or a different RAT. For example, in addition to being connected to RAN 604, which may be utilizing an E-UTRA radio technology, core network 606 may also be in communication with another RAN (not shown) employing a GSM radio technology.

Core network 606 may also serve as a gateway for WTRUs 602 to access PSTN 608, Internet 610, or other networks 612. PSTN 608 may include circuit-switched telephone networks that provide plain old telephone service (POTS). For LTE core networks, core network 606 may use IMS core 614 to provide access to PSTN 608. Internet 610 may include a global system of interconnected computer networks or devices that use common communication protocols, such as the transmission control protocol (TCP), user datagram protocol (UDP), or IP in the TCP/IP internet protocol suite. Other networks 612 may include wired or wireless communications networks owned or operated by other service providers. For example, other networks 612 may include another core network connected to one or more RANs, which may employ the same RAT as RAN 604 or a different RAT.

Some or all WTRUs 602 in telecommunication system 600 may include multi-mode capabilities. For example, WTRUs 602 may include multiple transceivers for communicating with different wireless networks over different wireless links. For example, one or more WTRUs 602 may be configured to communicate with base station 616, which may employ a cellular-based radio technology, and with base station 616, which may employ an IEEE 802 radio technology.

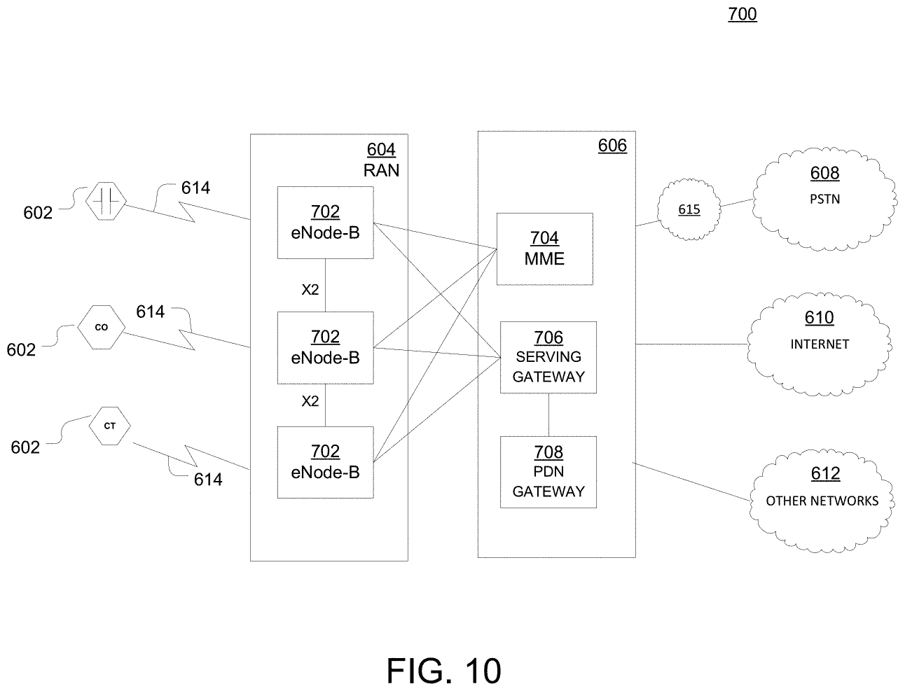

FIG. 10 is an example system 700 including RAN 604 and core network 606. As noted above, RAN 604 may employ an E-UTRA radio technology to communicate with WTRUs 602 over air interface 614. RAN 604 may also be in communication with core network 606.

RAN 604 may include any number of eNodeBs 702 while remaining consistent with the disclosed technology. One or more eNodeBs 702 may include one or more transceivers for communicating with the WTRUs 602 over air interface 614. Optionally, eNodeBs 702 may implement MIMO technology. Thus, one of eNodeBs 702, for example, may use multiple antennas to transmit wireless signals to, or receive wireless signals from, one of WTRUs 602.

Each of eNodeBs 702 may be associated with a particular cell (not shown) and may be configured to handle radio resource management decisions, handover decisions, scheduling of users in the uplink or downlink, or the like. As shown in FIG. 10 eNodeBs 702 may communicate with one another over an X2 interface.

Core network 606 shown in FIG. 10 may include a mobility management gateway or entity (MME) 704, a serving gateway 706, or a packet data network (PDN) gateway 708. While each of the foregoing elements are depicted as part of core network 606, it will be appreciated that any one of these elements may be owned or operated by an entity other than the core network operator.

MME 704 may be connected to each of eNodeBs 702 in RAN 604 via an 51 interface and may serve as a control node. For example, MME 704 may be responsible for authenticating users of WTRUs 602, bearer activation or deactivation, selecting a particular serving gateway during an initial attach of WTRUs 602, or the like. MME 704 may also provide a control plane function for switching between RAN 604 and other RANs (not shown) that employ other radio technologies, such as GSM or WCDMA.

Serving gateway 706 may be connected to each of eNodeBs 702 in RAN 604 via the S1 interface. Serving gateway 706 may generally route or forward user data packets to or from the WTRUs 602. Serving gateway 706 may also perform other functions, such as anchoring user planes during inter-eNodeB handovers, triggering paging when downlink data is available for WTRUs 602, managing or storing contexts of WTRUs 602, or the like.

Serving gateway 706 may also be connected to PDN gateway 708, which may provide WTRUs 602 with access to packet-switched networks, such as Internet 610, to facilitate communications between WTRUs 602 and IP-enabled devices.

Core network 606 may facilitate communications with other networks. For example, core network 606 may provide WTRUs 602 with access to circuit-switched networks, such as PSTN 608, such as through IMS core 614, to facilitate communications between WTRUs 602 and traditional land-line communications devices. In addition, core network 606 may provide the WTRUs 602 with access to other networks 612, which may include other wired or wireless networks that are owned or operated by other service providers.

While examples of described telecommunications system have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used, or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims. The term “or” as used herein is inclusive, unless provided otherwise.

Methods, systems, or computer-readable mediums of the subject matter of the present disclosure may be directed to receiving an origination location and a destination location, generating a coverage map comprising a plurality of coverage areas and one or more coverage overlaps based on the origination location and the destination location, determining one or more anchor base stations using the coverage map, determining a flight plan comprising a flight route and one or more flight rules used to travel from the origination location to the destination location, and transmitting the flight plan to one or more unmanned aerial vehicles (UAVs).

The methods, systems, or computer-readable mediums may further be directed to an instance where the one or more flight rules comprise a handover procedure for the one or more UAVs when switching connectivity between base stations when traversing the flight route.

The methods, systems, or computer-readable mediums may further be directed to an instance where the one or more flight rules instruct the one or more UAVs to connect to the one or more anchor base stations and prevents a connection to other base stations associated with the one or more coverage overlaps.

The methods, systems, or computer-readable mediums may further be directed to an instance where the other base stations have a higher signal strength or better SINK than the one or more anchor base stations.

The methods, systems, or computer-readable mediums may further be directed to an instance where the one or more UAVs is instructed to connect to the one or more base stations by lowering a s-measure value threshold.

The methods, systems, or computer-readable mediums may further be directed to an instance where the plurality of coverage areas and one or more coverage overlaps varies based on changes in altitude.

The methods, systems, or computer-readable mediums may further be directed to an instance where the flight route comprises a set of points from the origination location to the destination location, wherein each point comprises at least an altitude.

1. A device, the device comprising:
a processor; and
a memory coupled with the processor, the memory storing executable instructions that when executed by the processor, cause the processor to effectuate operations comprising:
receiving an origination location and a destination location;
generating a coverage map comprising a plurality of coverage areas and one or more coverage overlaps based on the origination location and the destination location;
determining one or more anchor base stations using the coverage map;
determining a flight plan comprising a flight route and one or more flight rules used to travel from the origination location to the destination location; and
transmitting the flight plan to one or more unmanned aerial vehicles (UAVs).

2. The device of claim 1, wherein the one or more flight rules comprise a handover procedure for the one or more UAVs when switching connectivity between base stations when traversing the flight route.

3. The device of claim 1, wherein the one or more flight rules instruct the one or more UAVs to connect to the one or more anchor base stations and prevents a connection to other base stations associated with the one or more coverage overlaps.

4. The device of claim 3, wherein the other base stations have a higher signal strength than the one or more anchor base stations.

5. The device of claim 1, wherein the one or more UAVs is instructed to connect to the one or more base stations by lowering a s-measure value threshold.

6. The device of claim 1, wherein the plurality of coverage areas and one or more coverage overlaps varies based on changes in altitude.

7. The device of claim 1, wherein the flight route comprises a set of points from the origination location to the destination location, wherein each point comprises at least an altitude.

8. A computer-implemented method for establishing a messaging session comprising:
receiving, by a processor, an origination location and a destination location;
generating, by the processor, a coverage map comprising a plurality of coverage areas and one or more coverage overlaps based on the origination location and the destination location;
determining, by the processor, one or more anchor base stations using the coverage map;
determining, by the processor, a flight plan comprising a flight route and one or more flight rules used to travel from the origination location to the destination location; and
transmitting, by the processor, the flight plan to one or more unmanned aerial vehicles (UAVs).

9. The computer-implemented method of claim 8, wherein the one or more flight rules comprise a handover procedure for the one or more UAVs when switching connectivity between base stations when traversing the flight route.

10. The computer-implemented method of claim 8, wherein the one or more flight rules instruct the one or more UAVs to connect to the one or more anchor base stations and prevents a connection to other base stations associated with the one or more coverage overlaps.

11. The computer-implemented method of claim 10, wherein the other base stations have a higher signal strength than the one or more anchor base stations.

12. The computer-implemented method of claim 8, wherein the one or more UAVs is instructed to connect to the one or more base stations by lowering a s-measure value threshold.

13. The computer-implemented method of claim 8, wherein the plurality of coverage areas and one or more coverage overlaps varies based on changes in altitude.

14. The computer-implemented method of claim 8, wherein the flight route comprises a set of points from the origination location to the destination location, wherein each point comprises at least an altitude.

15. A computer-readable storage medium storing executable instructions that when executed by a computing device cause said computing device to effectuate operations comprising:
receiving an origination location and a destination location;
generating a coverage map comprising a plurality of coverage areas and one or more coverage overlaps based on the origination location and the destination location;
determining one or more anchor base stations using the coverage map;
determining a flight plan comprising a flight route and one or more flight rules used to travel from the origination location to the destination location; and
transmitting the flight plan to one or more unmanned aerial vehicles (UAVs).

16. The computer-readable storage medium of claim 15, wherein the one or more flight rules comprise a handover procedure for the one or more UAVs when switching connectivity between base stations when traversing the flight route.

17. The computer-readable storage medium of claim 15, wherein the one or more flight rules instruct the one or more UAVs to connect to the one or more anchor base stations and prevents a connection to other base stations associated with the one or more coverage overlaps.

18. The computer-readable storage medium of claim 17, wherein the other base stations have a higher signal strength than the one or more anchor base stations.

19. The computer-readable storage medium of claim 15, wherein the one or more UAVs is instructed to connect to the one or more base stations by lowering a s-measure value threshold.

20. The computer-readable storage medium of claim 15, wherein the plurality of coverage areas and one or more coverage overlaps varies based on changes in altitude.
